(19) United States
(12) Patent Application Publication
(10) Pub. No.: US 2010/0222720 A1
(43) Pub. Date: Sep. 2, 2010

(54) Digit vibrating device and methods for use

(76) Inventor: Poonam Khubani, Saddle River, NJ (US)

Correspondence Address: COOPER & DUNHAM, LLP, 30 Rockefeller Plaza, 20th Floor, NEW YORK, NY, 10112, US

(21) Appl. No.: 12/586,953

(22) Filed: Sep. 29, 2009

Related U.S. Application Data
(60) Provisional application No. 61/208,871, filed on Feb. 27, 2009.

(51) Int. Cl. A61H 1/00

(52) U.S. Cl. 601/46

(57) ABSTRACT

This invention relates to devices which vibrate/massage and stretch a user's digits having a frame with two or more openings into which a user's digits are placed, including a vibrator separately provided within a unitary enclosure which is partially inserted into a recess in the frame. The unitary enclosure encloses the power source, a vibrator, and an interface to power on and off the vibrator. This invention also relates to methods for inserting/removing the unitary enclosure.

### CROSS REFERENCE TO RELATED APPLICATIONS

This application claims the benefit of U.S. Provisional Application No. 61/208,871 filed Feb. 27, 2009.

### BACKGROUND OF THE INVENTION

(1) Field of the Invention

This invention relates to a vibrating device, and more particularly, to a device to vibrate a user's digits which are inserted into a frame and to methods for inserting and removing the vibrating mechanism into and out of the frame.

(2) Description of Related Art

Digit-stretching devices have been created in which a user places a divider, such as a plastic post or cylinder, between the user's digits. Digit-stretching devices which also vibrate have been created, see, for example, U.S. Publication No. 2008/0113854 to Ferri. In the Ferri devices, the vibrating mechanism is entirely within the interior of the digit-stretcher, or is attached to an exterior portion of the device. However, when the vibrating mechanism is enclosed within the interior of the device, a power source located within the interior of the vibrating mechanism cannot be replaced, as no means for removal of such a power source is provided. Moreover, when the vibrating mechanism is entirely enclosed within the interior of the digit-stretcher, the vibrating mechanism can not be activated via direct contact. The Ferri devices use such elements as motion sensors or remote controls to actuate the vibrating mechanism. However, these elements add to the cost of manufacture, bulkiness and/or fragility of the device. Additionally, although a vibrator enclosed within the interior of the Ferri device uses energy to provide vibration to the digits, if the vibrating mechanism rotates, energy is wasted.

Also, when the vibrator is attached to the exterior of the digit-stretching device, for example at the top of the digit-stretching device, other disadvantages occur. First, since only a comparatively small portion of the vibrating mechanism is attached to the digit-stretching frame, energy is wasted vibrating the air particles around the vibrating mechanism, rather than the digit-stretcher which is in contact with the digits. Secondly, because the vibrating mechanism is connected to the digit-stretcher at a location comparatively far away from the digits themselves, only a portion of the energy which does in fact vibrate the digit-stretcher results in vibrating the digits themselves. Third, because the vibrating mechanism is exterior to the digit-stretcher portion of the device rather than making use of space and weight that is already allotted for the digit-stretcher portion of the device, the device is rendered bulky and heavy. Lastly, if the exterior connection between the vibrating mechanism and the digit-stretcher portion of the device is not secured, the vibrating mechanism wastes energy moving or rotating itself, which may also force the user to have to reposition the vibrating mechanism.

Therefore, a need exists for a new and improved device for the stretching and vibration of the digits that provides a superior connection between the vibrating mechanism and the digit-stretching portion of the device, and in particular a connection which is at least partially interior to the digit-stretching portion of the device and near the digits, in which the vibrating functionality is conveniently turned on and off, without the need for expensive production involving remote controls and sensors and the like and in which the vibrating mechanism does not waste energy-by potential movement or rotation, and in which the power source and vibrating mechanism can be conveniently inserted, removed and replaced.

### SUMMARY OF THE INVENTION

The present invention relates to a vibrating device, and in particular to a vibrating device having: a frame, the frame having at least two openings for insertion of at least two of a user's digits, and a recess; and a vibrating mechanism/means, the vibrating mechanism being a unitary enclosure which encloses a power source, a vibrating element which is powered by the power source, and an interface which is used to activate and deactivate the vibrating element, a portion of the unitary enclosure being inserted into the recess such that the interface includes an activator positioned on the surface of the unitary enclosure for access from outside of the frame.

In another aspect of the present invention, the recess: (1) extends into the frame such that at least a portion of the recess is between two of the openings; or (2) further extends through the frame.

In yet another aspect of the present invention, at least a portion of the power source is inserted into the portion of the recess which is between two of the openings.

In yet another aspect of the present invention, the interface is a switch.

In yet another aspect of the present invention, rotation of the vibrating mechanism within the recess is prevented: (1) by a tabbed portion of the vibrating mechanism and a space within the frame complementary to the tabbed portion of the vibrating mechanism which receives the tabbed portion of the vibrating mechanism; or (2) otherwise.

In yet another aspect of the present invention, the depth of insertion of the vibrating mechanism into the recess is limited: (1) by a tabbed portion of the vibrating mechanism and a portion of the recess which prevents further insertion of the tabbed portion of the vibrating mechanism; or (2) otherwise.

In yet another aspect of the present invention, the power source is replaced: (1) by accessing a portion of the vibrating mechanism extending beyond the recess without removing the vibrating mechanism from the recess; or (2) otherwise.

In yet another aspect of the present invention, the vibrating mechanism has a graspable part, at least a portion of the graspable part extending above the frame, the graspable part allowing the user to grasp the vibrating mechanism, and thereby to remove the vibrating mechanism from the frame.

In yet another aspect of the present invention, removal of a vibrating mechanism containing a graspable part from a recess contained in a frame is accomplished by: securing the frame containing the recess; grasping the graspable part of the vibrating mechanism; and applying a force to the graspable part in a direction away from the recess until the vibrating mechanism is removed from the recess.

In yet another aspect of the present invention, there is: a frame, the frame having at least two first openings for insertion of at least two of a user's digits, at least one divider separating the first openings, and a recess, such that at least a portion of the recess is within one of the dividers and connected to at least one of the first openings by at least one second opening; and a solid object, at least a portion of the solid object being inserted into the recess such that at least a portion of the solid object is within the divider, and adjacent to the at least one second opening.

In yet another aspect of the present invention, an object is inserted into a frame having at least two first openings for insertion of at least two of a user's digits, at least one divider separating the first openings, and a recess, such that at least a portion of the recess is within one of the dividers and connected to at least one of the first openings by the at least one second opening, by: applying force to the portion of the frame adjacent to the recess so as to increase the size of the at least one second opening; inserting the object into the recess; and ceasing to apply the force, which insertion may occur: (1) through a second opening; or (2) otherwise.

### BRIEF DESCRIPTION OF THE DRAWINGS

FIG. 1 is a front-view of a vibrating device according to one embodiment of the present invention;

FIG. 2 is a front-view of a vibrating mechanism 101 according to one embodiment of the present invention;

FIG. 3 is a front-view of a frame 102 according to one embodiment of the present invention; and

FIG. 4 is a top-view of a frame 102 according to one embodiment of the present invention.

### DETAILED DESCRIPTION OF THE INVENTION

The present invention relates to a vibrating device that is devised to separate and vibrate or massage the user's digits.

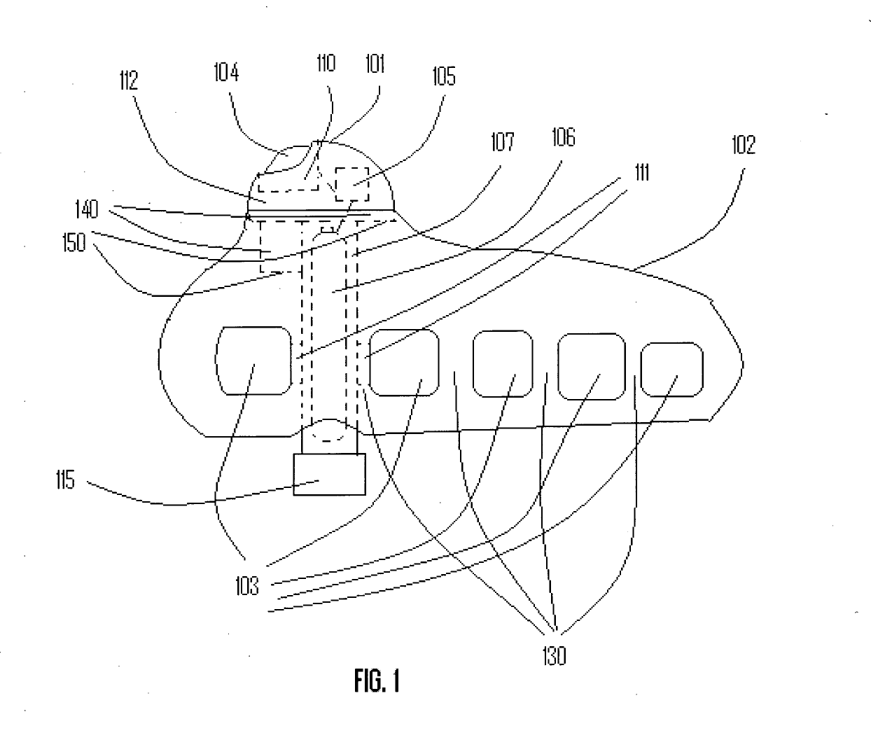

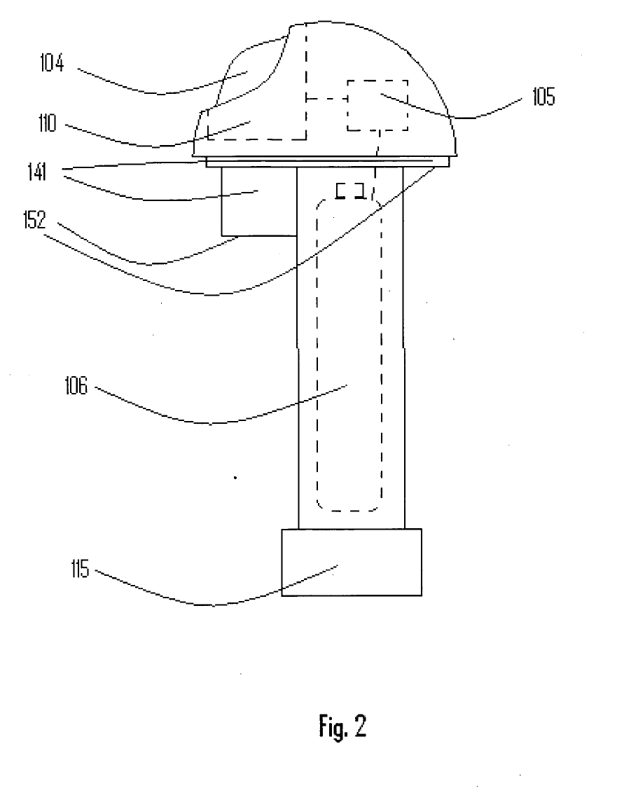

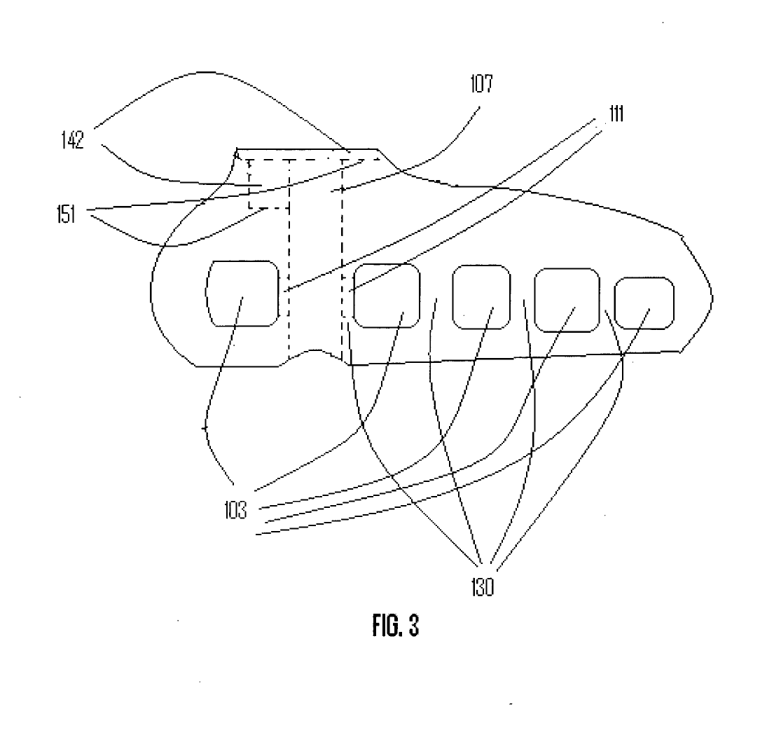

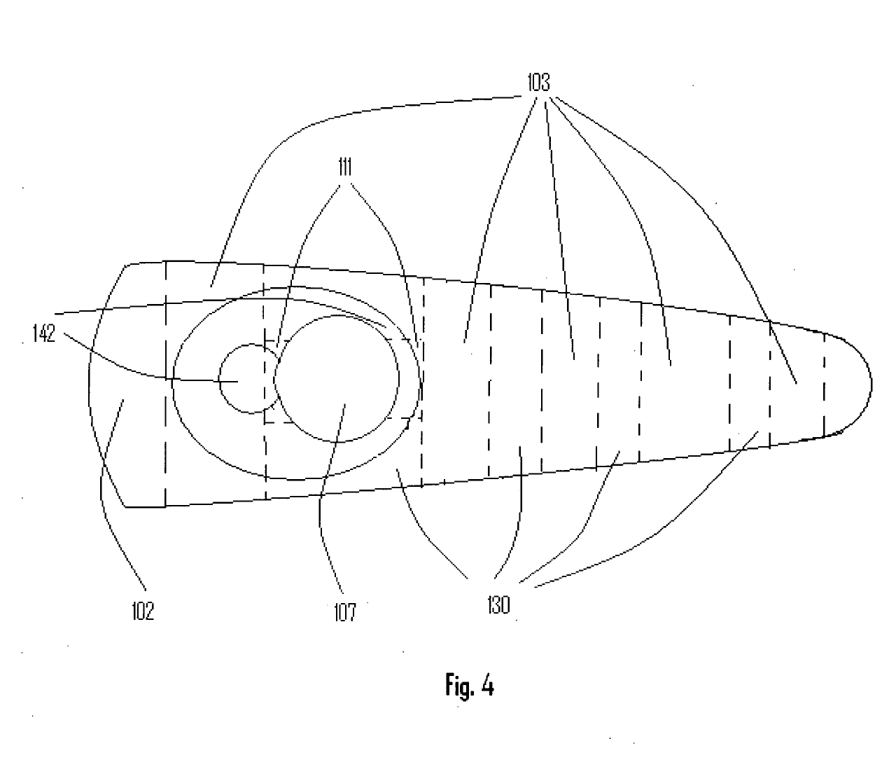

A vibrating device according to one embodiment of the present invention is shown in FIGS. 1-4. The vibrating device includes a frame 102, shown separately in FIGS. 3 and 4, having at least two openings 103 for insertion of at least two of a user's digits. The frame is made of any suitable material, such as a gel-like elastic material. The size of the openings 103 and the spacing between the openings 103 within the frame 102 may vary and depends on the size of the digits and the degree of digit separation of the user of the device. A recess 107 is formed in the frame 102 and has a size and shape to fit a corresponding vibrating mechanism 101, shown separately in FIG. 2, so as to optimize transfer of vibration from the vibrating mechanism 101 to the frame 102 and digits. The vibrating device includes such a vibrating mechanism 101.

The vibrating mechanism 101 according to one embodiment is formed as a unitary enclosure which encloses a power source 106, a vibrating element 105, shown only in block diagram form, which is powered by the power source 106, and an interface 110, also shown only in block diagram form, which is used to activate and deactivate the vibrating element 105. The unitary enclosure according to one embodiment is made of a hard substance such as inelastic plastic, although other appropriate materials may also be used.

The power source 106 may be any appropriate device for powering the vibrating element 105. In one embodiment, an alkaline battery is used. However, other power sources 106 such as a rechargeable battery or a solar cell may also be used. The vibrating element 105 may be any appropriate device that can be powered by the selected power source 106, which fits within the unitary enclosure, and which produces vibration. The interface 110 may be any appropriate device than can turn the vibrating element 105 on and off. The interface 110 includes an activator 104 positioned on the surface of the unitary enclosure for access from outside of the frame 102. The activator 104 may be any device which can be activated by the user from outside of the frame 102 and positioned on the surface of the unitary enclosure. In one embodiment, a button-switch is used, but other devices such as toggle-switches may also be used. Of particular note, in one embodiment the vibrating mechanism 101 is not inserted so far into the recess 107 that the activator 104 may only be accessed through the frame 102, as by squeezing a portion of the frame 102 near the activator 104. If access to the activator is only through the frame, turning the vibrating element 105 on or off can be unreliable.

In the embodiment shown in FIGS. 1-4, the recess 107 extends into the frame 102 such that at least a portion of the recess 107 is within the divider 130 between two of the openings 103. In this embodiment, when a vibrating mechanism 101 is inserted into this portion of the recess 107, vibration is efficiently carried to the digits which are inserted into these openings 103.

At least a portion of the power source 106 is inserted into the portion of the recess 107 which is between two of the openings 103. In this way, the device takes advantage of the natural spacing provided by the dividers 130 between digits to contain the power source 106 without contributing undesired bulk to the device. However, the power source 106 should not be so large as to require uncomfortably wide spacing of the digits, for example, use AAA batteries instead of ‘C’ cell batteries.

The recess 107 extends through the frame 102. In other words, the recess opens on one side of the frame 102 and also opens on a different side of the frame 102. This embodiment has the advantage of: (1) lowering the chance of air becoming trapped during insertion the vibrating mechanism 101 into the recess 107, which could make insertion difficult or make the fit between the vibrating mechanism 101 and the frame 102 less snug; (2) easily accommodating a vibrating mechanism 101 which is longer than the recess 107; and (3) allowing direct access by the user to two sides of the vibrating mechanism 101.

The device of this embodiment has an anti-rotation mechanism 140 for preventing rotation of the vibrating mechanism 101 within the recess 107. This anti-rotation mechanism 140 has a tabbed portion 141 of the vibrating mechanism 101 and a space 142 within the frame 102 complementary to the tabbed portion 141 of the vibrating mechanism 101 which receives the tabbed portion 141 of the vibrating mechanism 101. This anti-rotation mechanism 140 addresses the concern that the energy of the power source 106 is wasted by rotation of the vibrating mechanism 101, and/or that the user is forced to reorient the vibrating mechanism 101. When the tabbed portion 141 of the vibrating mechanism 101 is inserted into the space 142, the vibrating mechanism 101 may not be rotated, because doing so would merely result in pressing against portions of the frame 102 adjacent to the space 142. Other appropriate anti-rotation mechanisms 140 may be used, such as affixing the vibrating mechanism 101 and the frame 102 to each other, or increasing the friction between the vibrating mechanism 101 and the frame 102, with an adhesive such as glue or putty, or other elements of similar operation.

The device of this embodiment has an insertion-limiting mechanism 150 for limiting the depth of insertion of the vibrating mechanism 101 into the recess 107. This insertion-limiting mechanism 150 can be a part 152 of the a tabbed portion 141 of the vibrating mechanism 101 and the corresponding portion 151 of the recess 107 which prevents further insertion of the tabbed portion 141 into the recess 107. This insertion-limiting mechanism 150 addresses the concern that the energy of the power source 106 is wasted by driving the vibrating mechanism 101 further into recess 107, and the user is forced to reorient the vibrating mechanism 101. Other appropriate insertion-limiting mechanisms 150 may be used, such as affixing the vibrating mechanism 101 and the frame 102 to each other, or increasing the friction between the vibrating mechanism 101 and the frame 102, with an adhesive such as glue or putty, or other elements of similar operation.

The vibrating mechanism 101 has a replacement mechanism for replacement of the power source 106. This replacement mechanism is a power source compartment cap 115 which extends at least partially beyond the recess 107, such that the user may replace the power source 106 without removing the vibrating mechanism 101 from the recess 107. This replacement mechanism addresses the concern that if the energy of the power source 106 is consumed or if the power source 106 is otherwise rendered useless, the vibrating mechanism 101 can no longer vibrate, or the concern that replacement requires the user to remove the vibrating mechanism 101 from the recess 107. Other replacement mechanisms may be used, such as a removable covering for removal of the power source 106 through the top or side of the vibrating mechanism 101, or other elements of similar operation.

The vibrating mechanism 101 has a graspable part 112. A portion of the graspable part 112 extends above the frame 102. The graspable part 112 allows the user to grasp the vibrating mechanism 101, and thereby to remove the vibrating mechanism 101 from the frame 102. This graspable part 112 has the advantage of allowing easy removal of the vibrating mechanism 101 from the recess 107, for cleaning, repair, or any other appropriate purpose. Without such a graspable part 112, the user might, for example, be forced to use a tool to pry the vibrating mechanism 101 or vigorously shake the vibrating mechanism 101 in order to remove it, which occurrences would be time and energy consuming.

The removal of the vibrating mechanism 101 containing a graspable part 112 from a recess 107 contained in a frame 102 is accomplished by securing the frame 102 containing the recess 107, grasping the graspable part 112 of the vibrating mechanism 101, and applying a force to the graspable part 112 in a direction away from the recess 107 until the vibrating mechanism 101 is removed from the recess 107. Securing the frame 102 can be accomplished in any appropriate manner, such as by placing the user's hand or foot or another object atop the frame 102, by placing or keeping the user's digits within the frame 102, or by other elements of similar operation. Grasping the graspable part 112 of the vibrating mechanism 101 can be accomplished in any appropriate manner, such as by grasping with two fingers, with three fingers, with the palm of the hand, with multiple hands, or with a tool, or by other elements of similar operation. Applying force to the graspable part 112 can be accomplished in any appropriate manner, such as, if the frame 102 is secured away from the chest, by pulling towards the chest, or if the frame 102 is secured near the chest, by pulling away from the chest, or by other elements of similar operation.

The device of this embodiment has two second openings 111 within a divider 130 in the frame 102 which connect the two first openings 103 with the recess 107. A vibrating mechanism 101 is inserted into the recess 107 such that at least a portion of the vibrating mechanism 101 is within the divider 130, and adjacent to the second openings 111. The second openings allows for the user's digits to come into direct contact with the vibrating mechanism 101, allowing for direct application of vibration from the vibrating mechanism to the digits. Other appropriate solid objects may be inserted such that they are positioned between two first openings 103 and adjacent to at least one second opening 111, such as a heating device, a cooling device, an air-blower, or other elements of similar operation. Additional second openings 111 may be provided to connect the recess 107 to the same or other first openings 103. The second opening 111 may also allow for a space between the digit and the chosen solid object.

The insertion of the vibrating mechanism 101 into the frame 102 which has a divider 130 separating two of its first openings 103 and also has two second openings 111 connecting the recess 107 to the two first openings 103 can be accomplished by pressing the smaller end of the vibrating mechanism 101 into the recess 107 while holding the graspable part 112 and sliding the vibrating mechanism 101 into the recess 107 until the insertion-limiting mechanism 150 engages. The pressure applied has the effect of increasing the size of a portion of the recess, specifically by expanding the second openings 111. Insertion of the vibrating mechanism 101 into the recess 107 occurs through the top entrance to the recess as shown and oriented in FIG. 1. A vibrating mechanism 101 may also be inserted through other entrances, such as through a second opening 111, or inserted in any other suitable manner. When the insertion is complete, the frame 102 adjacent to the recess 107 which has increased in size will attempt to return to its original shape, providing a snug fit around the inserted portion of the vibrating mechanism 101.

The insertion in the present embodiment with the second openings has an advantage as during use the frame 102 tightly holds the vibrating mechanism 101, and less frictional resistance occurs during insertion. If the vibrating mechanism 101 is inserted through a second opening 111, which can be a comparatively large entrance after the application of force, there can be less frictional resistance to insertion.

The preceding description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

What is claimed is:

1. A vibrating device, comprising:
a frame, the frame having at least two openings for insertion of at least two of a user's digits, and a recess; and
a vibrating means, the vibrating means being a unitary enclosure enclosing a power source, a vibrating element which is powered by the power source, and an interface which is used to activate and deactivate the vibrating element, a portion of the unitary enclosure being inserted into the recess such that the interface includes an activator positioned on the surface of the unitary enclosure for access from outside of the frame.

2. The device as set forth in claim 1, wherein the recess extends into the frame such that at least a portion of the recess is between two of the openings.

3. The device as set forth in claim 2, wherein at least a portion of the power source is inserted into the portion of the recess which is between two of the openings.

4. The device as set forth in claim 1, wherein the recess extends through the frame.

5. The device as set forth in claim 1, wherein the interface is a switch.

6. The device as set forth in claim 1, wherein the device includes means for preventing rotation of the vibrating means within the recess.

7. The device as set forth in claim 1, wherein the device includes means for limiting the depth of insertion of the vibrating means into the recess.

8. The device as set forth in claim 1, wherein the vibrating means includes means for replacement of the power source.

9. The device as set forth in claim 8, wherein at least a portion of the means for replacement of the power source extends beyond the recess, such that the power source can be replaced without removing the vibrating means from the recess.

10. The device as set forth in claim 6, wherein the means for preventing rotation of the vibrating means within the recess comprises:
a tabbed portion of the vibrating means; and
a space within the frame complementary to the tabbed portion of the vibrating means which receives the tabbed portion of the vibrating means.

11. The device as set forth in claim 7, wherein the means for limiting the depth of insertion of the vibrating means into the recess comprises:
a tabbed portion of the vibrating means; and
a portion of the recess which prevents further insertion of the tabbed portion of the vibrating means.

12. The device as set forth in claim 1, wherein the vibrating means further comprises a graspable part, at least a portion of the graspable part extending above the frame, the graspable part allowing the user to grasp the vibrating means, and thereby to remove the vibrating means from the frame.

13. A method for the removal of a vibrating means containing a graspable part from a recess contained in a frame, which method comprises:
securing the frame containing the recess;
grasping the graspable part of the vibrating means; and
applying a force to the graspable part in a direction away from the recess until the vibrating means is removed from the recess.

14. A digit-holding device, comprising:
a frame, the frame having at least two first openings for insertion of at least two of a user's digits, at least one divider separating the first openings, and a recess, such that at least a portion of the recess is within one of the dividers and connected to at least one of the first openings by at least one second opening; and
a solid object, at least a portion of the solid object being inserted into the recess such that at least a portion of the solid object is within the divider, and adjacent to the at least one second opening.

15. A method for the insertion of an object into a frame, where the frame has at least two first openings for insertion of at least two of a user's digits, at least one divider separating the first openings, and a recess, such that at least a portion of the recess is within one of the dividers and connected to at least one of the first openings by the at least one second opening, which method comprises:
applying force to the portion of the frame adjacent to the recess so as to increase the size of the at least one second opening;
inserting the object into the recess; and
ceasing to apply the force.

16. The method as set forth in claim 16, wherein the object is inserted into the recess through one of the at least one second openings.
